(19) United States
(12) Patent Application Publication
(10) Pub. No.: US 2013/0117593 A1
(43) Pub. Date: May 9, 2013

(54) Low Latency Clock Gating Scheme for Power Reduction in Bus Interconnects

(71) Applicants: Prudhvi N. Nooney, Raleigh, NC (US); Jaya Prakash Subramaniam Ganasan, Youngsville, NC (US); Joseph L. Van Swearingen, Raleigh, NC (US); Richard Gerard Hofmann, Cary, NC (US)

(72) Inventors: Prudhvi N. Nooney, Raleigh, NC (US); Jaya Prakash Subramaniam Ganasan, Youngsville, NC (US); Joseph L. Van Swearingen, Raleigh, NC (US); Richard Gerard Hofmann, Cary, NC (US)

(73) Assignee: QUALCOMM INCORPORATED, San Diego, CA (US)

(21) Appl. No.: 13/290,250

(22) Filed: Nov. 7, 2011

(51) Int. Cl. G06F 1/32

(52) U.S. Cl. 713/322

(57) ABSTRACT

A System-on-a-Chip (SoC) comprising a controller, an activity counter, a reference pattern detection logic, a master pattern detection logic, an arbiter, a comparator, a tracker circuit, a delay cell circuit, and a request mask circuit coupled to a bus. The bus is configured to support master control. The controller is configured to cause components to enter a low power state. The activity counter is configured to monitor activity. The detection logics are configured to operate on an activity based clock or always on clock. The arbiter is configured to select an initiator. The comparator is configured to compare the output of the detection logics. The tracker circuit is configured to track selection of components. The delay cell circuit is configured to store output of components. The request mask circuit is configured to prevent request to arbiter or any arbiter selected request made from a previous clock cycle.

### FIELD OF DISCLOSURE

The present application relates to the field of system and circuit design, and more specifically to a low latency clock gating scheme for the reducing power in bus interconnects.

### BACKGROUND

System-on-a-chip (SoC) refers to integrating all components of a computer into a single integrated chip. It may contain digital, analog, mixed-signal, and radio-frequency functions on a single chip substrate. A typical SoC consists of: a microcontroller, microprocessor or digital signal processor core(s); memory blocks including a selection of ROM, RAM, EEPROM and flash; timing sources including oscillators and phase-locked loops; peripherals including counter-timers, real-time timers and power-on reset generators; external interfaces such as USB, Ethernet; analog interfaces; voltage regulators; and power management circuits. These blocks are all connected together by a bus.

A system-on-a-chip has bus masters or initiators, and bus slaves or targets. Each initiator reaches a target via a central arbiter. The central arbiter can adjudicate priority when multiple initiators request control at the same time. Additionally, each initiator and target may be running at different frequencies as compared to the central arbiter. Therefore, if the initiator or target needs to interface with the central arbiter, the initiator or target needs to be at the same clock frequency as the central arbiter. Typically, this can be done via a synchronization mechanism.

As shown in FIG. 1, a three-by-one crossbar interconnect can have up to 5 clock domains, which include the clock domains of initiators M0, M1, M2 101-103 and target S0 104, and the common clock domain for the arbiter 105. Each of the clock domains is serviced via a dedicated clock source (e.g., synchronous clock in FIG. 1) in the SoC. As illustrated in FIG. 1, the synchronous clock is the common clock domain where M0, M1, M2 and S0 communicate. Each of these clock domains is driven by a clock tree structure.

In a synchronous system, the clock signal defines a time reference for the movement of data within the system. The clock tree or clock distribution network distributes the clock signal from a common point to all the elements that need to be synchronized. Additionally, the clock tree takes a significant fraction of the power consumed by a chip. A substantial amount of interconnect power consumption in a SoC is in the clock tree.

A clock can be safely gated by design to save power. Clock gating is used in many synchronous circuits for reducing dynamic power dissipation. Clock gating saves power by adding more logic to a circuit to prune the clock tree. Pruning the clock disables portions of the circuitry so that the flip-flops in them do not have to switch states. Switching states consumes power. As a result, interconnect power is predominantly due to dynamic power consumption due to interconnect capacitance switching. When not being switched (e.g., when the clocks are gated), the switching power consumption goes to zero, so only leakage currents are incurred.

Based on the activity of initiator or target, individual clocks and interface clocks to arbiter can be turned off to save clock tree power. A signal is sent to the clock controller indicating that there is no activity on the bus, and the interconnect wishes to enter a low power state by gating off the clocks to all the initiators, targets and the core of the bus interconnect.

However, there are inherent latency problems, as discussed in FIGS. 2A-3B, associated with dynamically gating the clocks for achieving low power for an SoC. The clocks are required to be ON when a transfer occurs but there is latency, or extra clock cycles wasted, when turning a clock ON from an OFF state. This results in an increased latency from the initiator to the target. In latency-sensitive applications, specifically for time sensitive applications, such increased latency is undesirable. The preferred implementation for any clock gating scheme for any interconnect would attempt to minimize this latency. The present invention reduces the latency during clock gating.

### SUMMARY

The described features generally relate to one or more improved systems, methods and/or apparatuses for the field of system and circuit design, and more specifically to a low latency clock gating scheme for low power bus interconnects.

Further scope of the applicability of the described methods and apparatuses will become apparent from the following detailed description, claims, and drawings. The detailed description and specific examples, while indicating specific examples of the disclosure and claims, are given by way of illustration only, since various changes and modifications within the spirit and scope of the description will become apparent to those skilled in the art.

In one embodiment, a System-on-a-Chip (SoC) is disclosed. The SoC may comprise: A System-on-a-Chip (SoC) comprising: a bus for supporting master control within the SoC; a controller coupled to the bus, the controller being configured to cause components within the SoC to enter a low power state; an activity counter coupled to the controller and configured to monitor activity within the SoC; a reference pattern detection logic coupled to the bus clocked by an always on clock; a master pattern detection logic coupled to the bus configured to operate on an activity based clock; an arbiter coupled to the bus configured to select an initiator; a comparator coupled to the bus configured to compare the reference pattern detection logic and the master pattern detection logic; a tracker circuit coupled to the bus for tracking selection of components within the SoC; a delay cell circuit coupled to the bus for storing output of components within the SoC; and a request mask circuit coupled to the bus, configured to prevent request to arbiter or any arbiter selected request made from a previous clock cycle depending on the tracker circuit and the delay cell circuit.

Another embodiment, may include a System-on-a-Chip (SoC) comprising: a bus with a master clock; a clock controller coupled to the bus, the clock controller being configured to gate off at least one of the clocks for SoC to enter low power state; a bus interface activity counter coupled to the clock controller for generating a bus interface signal, and the bus interface activity counter being configured to count inactivity cycles and signal the clock controller to gate off the clocks; a reference pattern detection logic coupled to the bus clocked by an always on clock; a master pattern detection logic coupled to the bus configured to operate on an activity based clock; an arbiter coupled to the bus configured to select a initiator; a comparator coupled to the bus configured to compare the reference pattern detection logic with the master pattern detection logic to determine the master clock is active; a tracker circuit coupled to the bus for tracking arbiter selection; a delay cell circuit coupled to the bus for storing output of the comparator from previous clock cycles; a request mask circuit coupled to the bus, configured to prevent subsequent requests to the arbiter and any arbiter selected request made from previous clock cycles, if the comparison of the tracker circuit output and the delay cell circuit output is unequal.

Another embodiment may include a method for reducing latency in a System-on-a-Chip (SoC), the SoC having a bus with a master clock, a controller coupled to the bus, an arbiter coupled to the bus configured to select an initiator, comprising: monitoring activity within the SoC by an activity counter; receiving a reference pattern detection logic clocked by an always on clock; receiving a master pattern detection logic configured to operate on an activity based clock; comparing the reference pattern detection logic and the master pattern detection logic by a comparator; tracking selection of components within the SoC by a tracker circuit; storing output of components within the SoC by a delay cell circuit; and preventing request to arbiter and any arbiter selected request made from a previous clock cycle, depending on the tracker circuit and the delay cell circuit, by a request mask circuit.

Another embodiment may include an apparatus for reducing latency in a System-on-a-Chip (SoC), the SoC having a bus with a master clock, a controller coupled to the bus, an arbiter coupled to the bus configured to select an initiator, the apparatus comprising: logic configured to cause components within the SoC to enter a low power state; logic configured to monitor activity within the SoC; logic configured to be a reference pattern detection logic clocked by an always on clock; logic configured to be a master pattern detection logic to operate on an activity based clock; logic configured to be a comparator to compare the reference pattern detection logic and the master pattern detection logic; logic configured to be a tracker circuit to track selection of components within the SoC; logic configured to be a delay cell circuit to store output of components within the SoC; and logic configured to be a request mask circuit to prevent request to an arbiter and any arbiter selected request made from previous clock cycles depending on the tracker circuit output and the delay cell circuit output.

Another embodiment may include an apparatus for reducing latency in a System-on-a-Chip (SoC), the SoC having a bus with a master clock, a controller coupled to the bus, an arbiter coupled to the bus configured to select an initiator, the apparatus comprising: means for monitoring activity within the SoC by an activity counter; means for receiving a reference pattern detection logic clocked by an always on clock; means for receiving a master pattern detection logic configured to operate on an activity based clock; means for comparing the reference pattern detection logic and the master pattern detection logic by a comparator; means for tracking selection of components within the SoC by a tracker circuit; means for storing output of components within the SoC by a delay cell circuit; and means for preventing request to the arbiter and any arbiter selected request made from previous clock cycles, depending on the tracker circuit output and the delay cell circuit output, by a request mask circuit.

### BRIEF DESCRIPTION OF THE DRAWINGS

The features, objects, and advantages of the disclosed methods and apparatus will become more apparent from the detailed description set forth below when taken in conjunction with the drawings in which like reference characters identify correspondingly throughout.

FIG. 1 is a block diagram of a three-by-one crossbar system with three masters (M0-M2), an arbiter, and a source (S0).

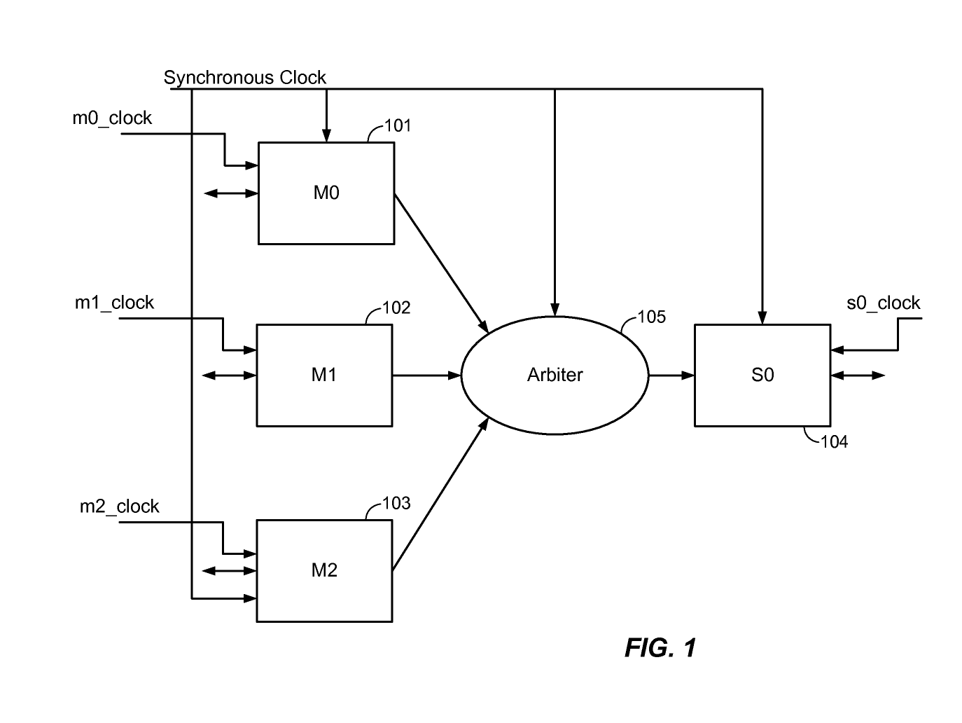

FIG. 2A is a flowchart illustrating inherent problems with conventional dynamic clock gating system between bus initiators/target and the interconnect.

FIG. 2B is a timing diagram depicting the problem of multiple request by a master associated with dynamic clock gating illustrated in FIG. 2A.

FIG. 3A is a flowchart illustrating a conventional solution for resolving the dynamic clock gating issue of FIG. 2A.

FIG. 3B is a timing diagram describing an example of the conventional solution depicted in FIG. 3A.

FIG. 4 is a block diagram illustrating an example of a circuit according to an embodiment of the present invention addressing the latency issue for a dynamic clock gating implementation.

FIG. 5 is a timing diagram illustrating the advantages conferred by an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Clock gating logic can be added into a design in a variety of ways. The clock gating logic can be coded into the Register Transfer Language (RTL) code as enable conditions that can be automatically translated into clock gating logic by synthesis tools, known as fine grain clock gating. Alternatively, the clock gating logic can be inserted into the design manually by the RTL designers, typically as module level clock gating, by instantiating library specific integrated clock gating (ICG) cells to gate the clocks of specific modules or registers. Alternatively, the clock gating logic can be semi-automatically inserted into the RTL by automated clock gating tools. These tools either insert ICG cells into the RTL, or add enable conditions into the RTL code.

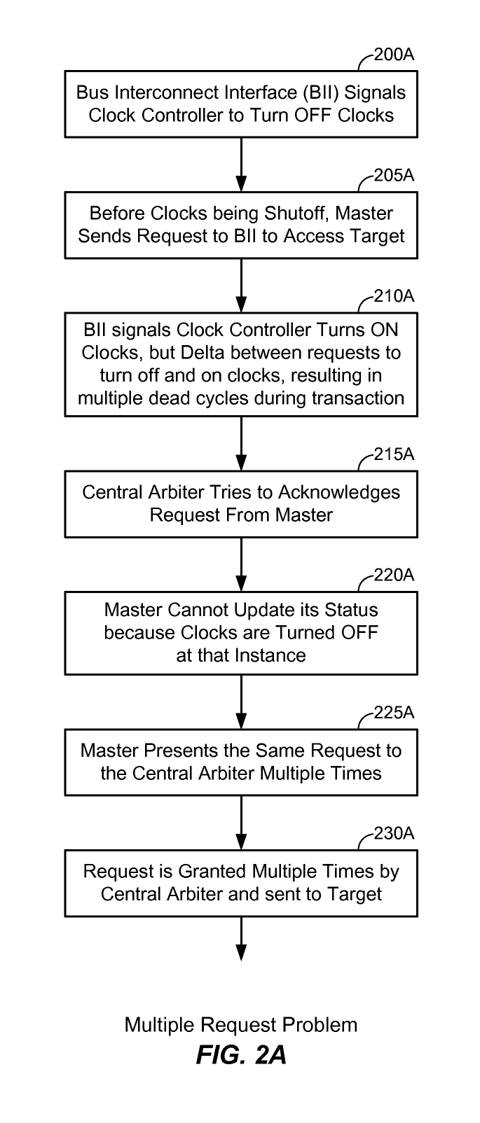

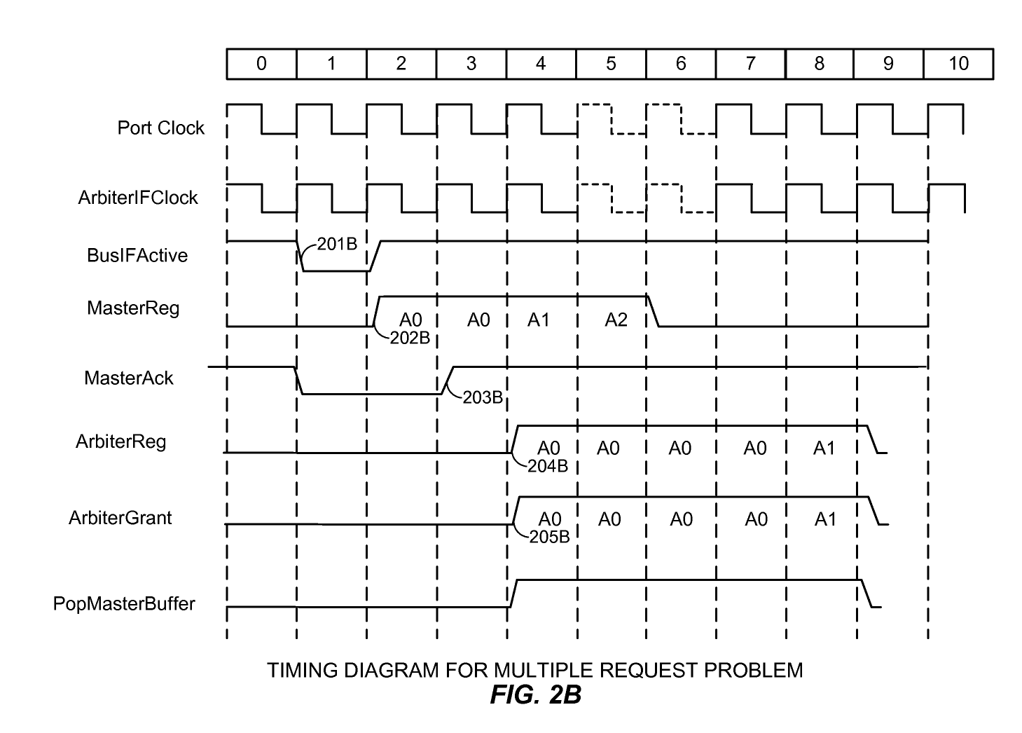

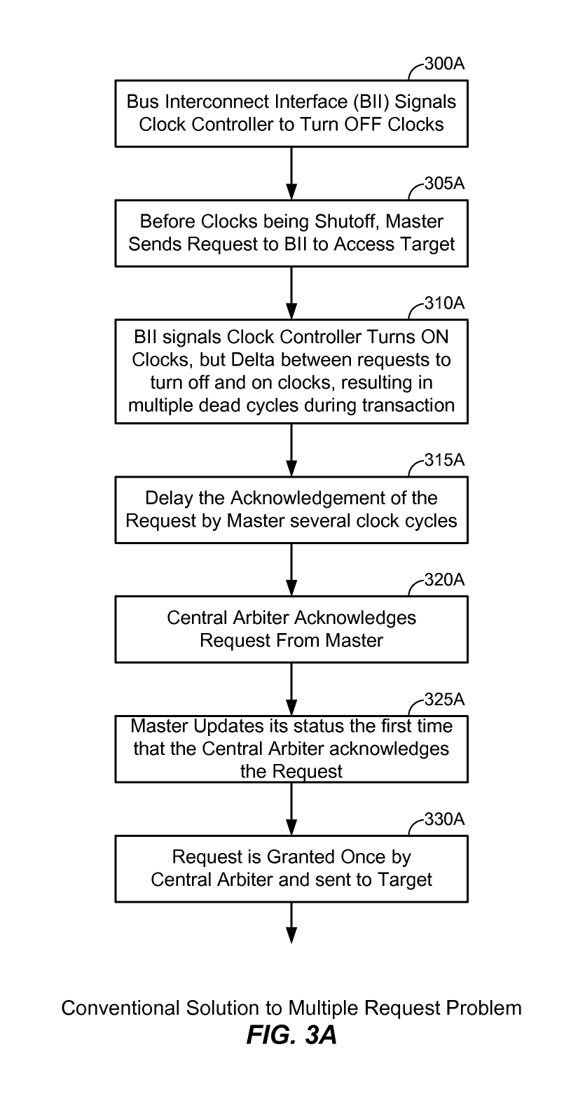

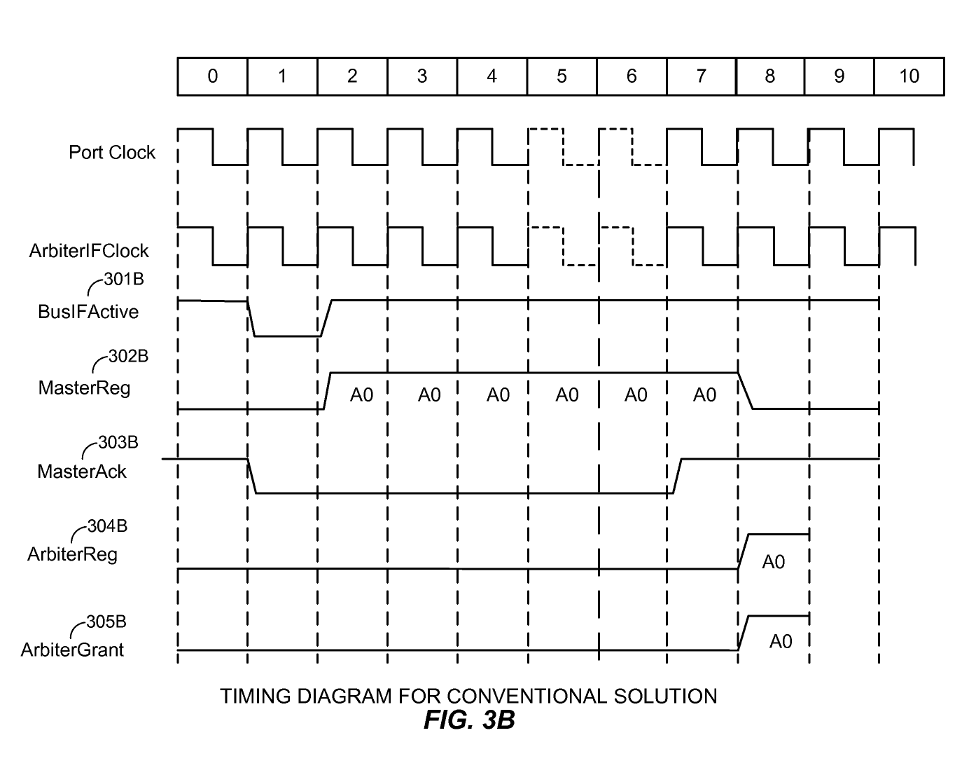

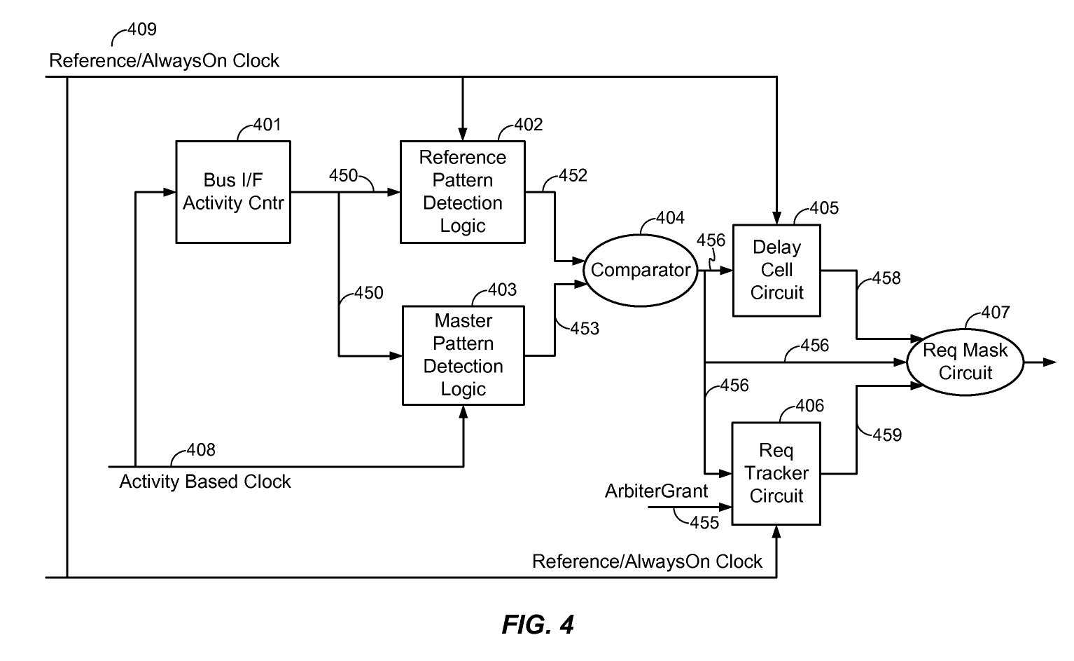

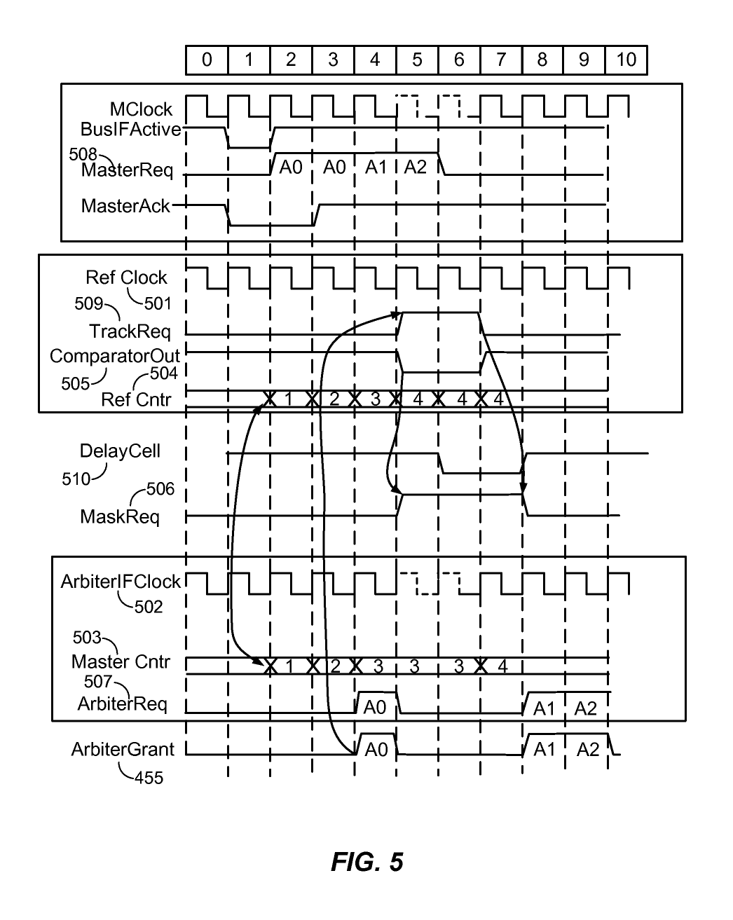

FIG. 2A is a flowchart illustrating an example of unwanted multiple request by the master to the central arbiter as associated with dynamic clock gating. One of the problems associated with clock gating is when the Master Clock is turned off when the request by the Master is acknowledged by the Central Arbiter, which results in multiple requests by the Master. FIGS. 3A and 3B illustrate a conventional solution for preventing multiple requests by the Master, but the conventional solution inherently incurs additional latency. FIGS. 4 and 5 illustrate an example of the present invention, where multiple requests by the Master are prevented, while also reducing latency.

Referring to FIG. 2A, multiple requests by the Master can occur when the Bus Interconnect Interface (BII) signals the Clock Controller to turn off clocks, at 200A. In order to save power, the BII usually signals to turn off the clocks when there is no activity in the interconnect. However, in the special case before the clocks are actually shutoff, the Master can send a request to the BII to allow the Master to access the Target, at 205A. When BII receives this request, BII signals the Clock Controller to turn on the clocks, at 210A. However, there is a delta between the requests to turn off and on clocks, resulting in multiple dead cycles during transaction. As a result, when the Central Arbiter tries to acknowledge request from the Master, at 215A, the clocks are turned off so the Master cannot update its status, at 220A. Therefore, the Master presents the same request to the Central Arbiter multiple times, at 225A. Since, at that point, the Central Arbiter and Target clocks are active; the request is granted multiple times by central Arbiter and sent multiple times to Target, at 230A.

FIG. 2B is a timing diagram depicting the problem of multiple requests by a master associated with the dynamic clock gating illustrated in FIG. 2A. For example, when there is not any traffic in the crossbar interconnect, the Bus Interconnect Interface (BII), based on programmable activity on the interface, sends a low (e.g., OFF) BusIFActive (Bus Interface Active) signal 201B to either a global or local clock controller to turn off the clocks during cycle 1. However, it is possible during clock cycle 2, for the Master (M0) 101 to send a request MasterReq signal 202B to the BII to access the target (S0) 104, because the clocks have not been shut off by the clock controller yet. This new request by the Master (M0) 101 is a new activity on the interconnect; therefore the BII signals the clock controller, during clock cycle 2, to ignore the previous request to turn off the clocks via a high (e.g., ON) BusIFActive signal 201B. In an SoC implementation, the BusIFActive signal 201B has no specific timing requirements. Consequently, there is a delta in time between the requests to turn the clocks on and off, which results in the clock incurring multiple dead cycles during the transaction. When the central arbiter 105 acknowledges the request by the MasterReq signal 202B from cycle 2 and turns on MasterAck signal 203B during cycle 3, the request is then synchronized into central arbiter 105 clock domain as shown by ArbiterReq signal 204B being turned on in cycle 4.

This example in FIG. 2B illustrates that during clock cycle 1, the BusIFActive signal 201B is low in order to indicate that there is not any traffic in the crossbar interconnect. The low BusIFActive signal 201B causes the clock controller to turn OFF the clocks momentarily, until the BusIFActive signal 201B turns back to high during clock cycle 2 via another request by the BII. The high BusIFActive signal 201B causes the clock controller to turn the clocks back ON. In addition, before all the clocks are turned back ON, the clock for the Master (M0) is momentarily OFF when the Master (M0) presents a request to the central arbiter 105 via the MasterReq signal 202B. During clock cycle 4, the central arbiter 105 tries to grant the request through ArbiterGrant signal 205B and the clocks are turned OFF at that instance, thus, the Master (M0) cannot update its status. Since the Master (M0) cannot update its status, the Master (M0) presents the same request multiple times to the central arbiter 105 until the clock comes back ON for the Master (M0). As a result, since the central arbiter 105 and target clocks are still active, the ArbiterReq signal 204B is duplicated three times and sent to the target (S0) 104.

FIG. 3A is a flowchart illustrating a conventional solution for resolving the dynamic clock gating issue of FIG. 2A. A conventional solution for preventing multiple requests by the Master is to delay acknowledgment from the Central Arbiter by several clock cycles. Similar to FIG. 2A, multiple requests by the Master to access the Target can occur in special cases (e.g., right before the clocks are turned off during clock gating). Therefore blocks 300A, 305A and 310A are similar to blocks 200A, 205A, and 210A, respectively. Unlike FIG. 2A, the conventional solution delays acknowledgment of the request by the Master by several cycles, at 315A. While the delay prevents multiple requests and grants, it does result in wasted clock cycles and thus latency. The delay is usually design specific and varies among different SoCs. After the delay, the Central Arbiter acknowledges the request from the Master, at 320A. The delay ensures the clocks are turned back cleanly before interconnect master port accepts the transaction. Therefore the Master updates its status the first time that the Central Arbiter acknowledges the request, at 325A. As a result, the request is granted once by the Central Arbiter and sent to Target, at 330A.

FIG. 3B is a timing diagram describing an example of the conventional solution depicted in FIG. 3A. By delaying the re-assertion of MasterAck 303B by several clock cycles when a Master (M0) asserts MasterReq 302B, if the BusIFActive 301B is active low, the ArbiterReq 304B is sent only once. Unlike FIG. 2B, by delaying the re-assertion of MasterAck 203B, it prevents ArbiterReq 204B being duplicated and sent three times to the target (S0) 104. The delay cycles are dependent on specific physical design implementation, which depends on the delay from the clock enable signal arriving at the clock gating cell. However, this conventional implementation adds complexity to software, which is required to program the right number of cycles for each interface. In addition, this conventional implementation adds extra latency or turn-on delay latency. As depicted in FIG. 3B, MasterReq 302B is requested in clock cycle 2, but the ArbiterReq 304B is granted by the central arbiter 105 in cycle 8, which may add five additional cycles of latency.

FIG. 4 is a block diagram illustrating a circuit addressing the issue of dynamic clock gating according to an embodiment of the present invention. The present invention allows for a system that is independent to the number of cycles it takes for clock controller or clock gating cell to turn off the clocks. The present invention allows for a system that is independent to the number of dead clock cycles added by turning on and off the clocks to the interconnect. In addition, the present invention minimizes the latency impact due to clock gating for transactions sent from an initiator (e.g., M0-M2 101-103) to a target S0 104. The present invention creates a low power implementation that has minimum or no impact to overall bus performance. The present invention can remove overhead from software programming of counters as needed by the conventional implementation shown in FIG. 3A.

The block diagram in FIG. 4 illustrates an example of a circuit implementation for an embodiment of the present invention. A bus interface activity counter 401, counts the inactivity cycles from the activity based clock 408. The activity based clock 408 signals clock controller or clock gating cell to turn off the clocks.

Still referring to FIG. 4, a reference pattern detection logic 402, which is clocked by a Reference/AlwaysOn clock 409, is coupled to the bus interface activity counter output 450. An example of pattern detection logic includes, but is not limited to a counter or a shift register. Any pattern matching logic can be used, where for example the logic compares an AlwaysOn clock 409 with an activity based clock 408. The reference pattern detection logic 402 has an input gate which receives the output signal from the bus interface activity counter 401.

Continuing to refer to FIG. 4, a master pattern detection logic 403, similar to the bus interface activity counter 401, is clocked by the activity based clock 408. The master pattern detection logic 403 is coupled to the bus interface activity counter output 450. The master pattern detection logic 403 has an input gate which receives the output signal from the bus interface activity counter 401.

The reference pattern detection logic 402 and master pattern detection logic 403 are enabled when the bus interface activity counter 401 through the activity based clock 408 has expired. In relation to FIG. 5, ArbiterIFClock signal 502 from FIG. 5 corresponds to activity based clock signal 408 from FIG. 4. In addition, Ref Clock signal 501 from FIG. 5 corresponds to the Reference/AlwaysOn clock signal 409 from FIG. 4.

A comparator 404, which is coupled to the reference pattern detection logic output 452 and also coupled to the master pattern detection logic output 453, determines if master clock is active or inactive based on the relationship of clocks to the reference pattern detection logic 402 and master pattern detection logic 403.

In relation to FIG. 5, Master Cntr 503 from FIG. 5 corresponds to output signal (e.g., master pattern detection logic output 453) of the master pattern detection logic 403 from FIG. 4. Additionally, Ref Cntr 504 from FIG. 5 corresponds to the output signal (e.g., reference pattern detection logic output 452) of the reference pattern detection logic 402 from FIG. 4. Furthermore, ComparatorOut signal 505 from FIG. 5 is the output signal (e.g., comparator output 456) from the comparator 404 in FIG. 4. As iterated earlier, any pattern matching logic that compares an AlwaysOn 409 clock with another logic clocked by an activity based clock can be implemented as the pattern detection logic.

FIG. 5 is a timing diagram describing an example of the present invention, where latency, as illustrated in FIG. 3B, is minimized, while also resolving the dynamic clock gating issue of FIG. 2B. The dynamic clock gating issue occurs, as previously discussed in the example from FIG. 2B, because ArbiterReq 204 is duplicated and sent several times to the target (S0) 104.

Referring to the FIG. 5 timing diagram, CAMPARATOROUT 505 is triggered into a low voltage or OFF state in cycle 5 when the Ref Cntr 504 (e.g., Ref Cntr=4) and the Master Cntr 503 (e.g., Master Cntr=3) are unequal. This occurs because the ARBITERIFCLOCK signal 502 in FIG. 5 is turned OFF during cycle 5, which triggers MaskReq signal 506 from FIG. 5 to be asserted and the request from the master (e.g., M0 101) to the bus arbiter (e.g., central arbiter 105) is masked.

A Request Tracker Circuit 406, which is coupled to the comparator output 456, tracks if ArbiterGrant signal 455 in FIG. 4 and FIG. 5 has occurred in the last cycle before master clocks are actually turned off. The TrackReq signal 509 from FIG. 5 depicts the Request Tracker Circuit output 459.

As illustrated in FIG. 5, the TRACKREQ signal 509 is ON in cycle 5, when the ArbiterGrant signal 455 is ON during cycle 4. As illustrated in FIG. 5, the TRACKREQ signal 509 is ON in cycle 5 and 6, when the COMPARATOROUT signal 505 is OFF during cycle 5 and 6.

The Delay Cell Circuit 405, which is coupled to the comparator output 456, stores the previous output value of comparator 404. The DELAYCELL signal 510 from FIG. 5 depicts the Delay Cell Circuit output 458.

As illustrated in FIG. 5, the DELAYCELL signal 510 outputs the previous value of the CAMPARATOROUT signal 505.

The Request Mask Circuit 407 is coupled to the comparator output 456, to the Delay Cell Circuit output 458, and Request Tracker Circuit output 459. The Request Mask Circuit 407 masks request to the central arbiter 105 thereby preventing the same request from being granted multiple times. By preventing the same Master request (e.g., MasterReq 508) from being granted multiple times from Central Arbiter (e.g., ArbiterReq 507), the present invention resolves the issue of dynamic clock gating as illustrated in FIG. 2B.

Tying together FIG. 4 and FIG. 5, the MASKREQ signal 506 from FIG. 5 depicts the output signal from the Request Mask Circuit 407. The MASKREQ signal 506 is dependent on the TRACKREQ signal 509, the DELAYCELL signal 510, and the COMPARATOROUT signal 505.

The Request Mask Circuit 407 can mask request during the following situations: (i) the comparator output 456 results in inequality (e.g., activity based clock 408 is turned OFF); (ii) the Request Tracker Circuit output 459 is TRUE, meaning ArbiterGrant 455 has happened in the last cycle before activity based clock is actually turned OFF; or (iii) the Delay Cell Circuit output 458 is TRUE.

To summarize, the Request Mask Circuit 407 can mask any subsequent request and any arbiter selected request made one cycle before the inequality can be prevented from being sent to arbiter until clock for the master interface to the arbiter comes back alive.

As shown in the timing diagram illustrated in FIG. 5 of an embodiment of the present invention depicted in FIG. 4, the advantage conferred by the present invention is that the first request A0 is granted by central arbiter 105 in cycle 4, which is four clock cycles gain than the conventional implementation depicted in FIG. 3B.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for clock gating. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A System-on-a-Chip (SoC) comprising:
a bus for supporting master control within the SoC;
a controller coupled to the bus, the controller being configured to cause components within the SoC to enter a low power state;
an activity counter coupled to the controller and configured to monitor activity within the SoC;
a reference pattern detection logic coupled to the bus clocked by an always on clock;
a master pattern detection logic coupled to the bus configured to operate on an activity based clock;
an arbiter coupled to the bus configured to select an initiator;
a comparator coupled to the bus configured to compare the reference pattern detection logic and the master pattern detection logic;
a tracker circuit coupled to the bus for tracking selection of components within the SoC;
a delay cell circuit coupled to the bus for storing output of components within the SoC; and
a request mask circuit coupled to the bus, configured to prevent request to arbiter or any arbiter selected request made from a previous clock cycle depending on the tracker circuit and the delay cell circuit.

2. The SoC of claim 1, wherein the controller is a clock controller being configured to gate off at least one of the clocks within the SoC to enter the low power state.

3. The SoC of claim 1, wherein the activity counter is configured to monitor activity within the SoC.

4. The SoC of claim 1, wherein the activity counter is a bus interface activity counter that counts inactivity cycles and signals the controller to gate off at least one of the clocks.

5. The SoC of claim 1, wherein the comparator compares the reference pattern detection logic with the master pattern detection logic to determine if a master clock is active.

6. The SoC of claim 1, wherein the tracker circuit tracks an arbiter selection.

7. The SoC of claim 1, wherein the delay cell circuit stores output of the comparator from the previous clock cycle.

8. The SoC of claim 1, wherein the request mask circuit is configured to prevent subsequent requests to arbiter and any arbiter selected request made from the previous clock cycle, if comparison of the tracker circuit output and the delay cell circuit output is unequal.

9. A System-on-a-Chip (SoC) comprising:
a bus with a master clock;
a clock controller coupled to the bus, the clock controller being configured to gate off at least one of the clocks for SoC to enter low power state;
a bus interface activity counter coupled to the clock controller for generating a bus interface signal, and the bus interface activity counter being configured to count inactivity cycles and signal the clock controller to gate off the clocks;
a reference pattern detection logic coupled to the bus clocked by an always on clock;
a master pattern detection logic coupled to the bus configured to operate on an activity based clock;
an arbiter coupled to the bus configured to select a initiator;
a comparator coupled to the bus configured to compare the reference pattern detection logic with the master pattern detection logic to determine the master clock is active;
a tracker circuit coupled to the bus for tracking arbiter selection;
a delay cell circuit coupled to the bus for storing output of the comparator from previous clock cycles;
a request mask circuit coupled to the bus, configured to prevent subsequent requests to the arbiter and any arbiter selected request made from previous clock cycles, if the comparison of the tracker circuit output and the delay cell circuit output is unequal.

10. A method for reducing latency in a System-on-a-Chip (SoC), the SoC having a bus with a master clock, a controller coupled to the bus, an arbiter coupled to the bus configured to select an initiator, comprising:
monitoring activity within the SoC by an activity counter;
receiving a reference pattern detection logic clocked by an always on clock;
receiving a master pattern detection logic configured to operate on an activity based clock;
comparing the reference pattern detection logic and the master pattern detection logic by a comparator;
tracking selection of at least one component within the SoC by a tracker circuit;
storing output of at least one component within the SoC by a delay cell circuit; and
preventing request to arbiter and any arbiter selected request made from a previous clock cycle, depending on the tracker circuit output and the delay cell circuit output, by a request mask circuit.

11. The method of claim 10, wherein the controller is a clock controller further comprising:
gating off at least one of the clocks for SoC to enter low power state by the clock controller.

12. The method of claim 10, wherein the activity counter is a bus interface activity counter, further comprising:
controlling activity within the SoC by the bus interface activity counter;
counting inactivity cycles by the bus interface activity counter; and
signaling, from the bus interface activity counter to a clock controller, to gate off at least one of the clocks.

13. The method of claim 10, further comprising:
comparing the reference pattern detection logic with the master pattern detection logic to determine if the master clock is active, by the comparator.

14. The method of claim 10, further comprising:
tracking the arbiter selection by the tracker circuit.

15. The method of claim 10, further comprising:
storing the output of the comparator from the previous clock cycle by the delay cell circuit.

16. The method of claim 10, further comprising:
preventing subsequent requests to arbiter and any arbiter selected request made from the previous clock cycle, by the request mask circuit, if comparison of the tracker circuit output and the delay cell circuit output is unequal.

17. An apparatus for reducing latency in a System-on-a-Chip (SoC), the SoC having a bus with a master clock, a controller coupled to the bus, an arbiter coupled to the bus configured to select an initiator, the apparatus comprising:
logic configured to cause components within the SoC to enter a low power state;
logic configured to monitor activity within the SoC;
logic configured to be a reference pattern detection logic clocked by an always on clock;
logic configured to be a master pattern detection logic to operate on an activity based clock;
logic configured to be a comparator to compare the reference pattern detection logic and the master pattern detection logic;
logic configured to be a tracker circuit to track selection of components within the SoC;
logic configured to be a delay cell circuit to store output of components within the SoC; and
logic configured to be a request mask circuit to prevent request to an arbiter and any arbiter selected request made from previous clock cycles depending on the tracker circuit output and the delay cell circuit output.

18. The apparatus of claim 17, further comprising:
logic configured to gate off at least one of the clocks for SoC to enter low power state.

19. The apparatus of claim 17, further comprising:
logic configured to control activity within the SoC;
logic configured to count inactivity cycles on the bus; and
logic configured to signal to the controller to gate off at least one of the clocks.

20. The apparatus of claim 17, further comprising:
logic configured to compare the reference pattern detection logic with the master pattern detection logic to determine if the master clock is active.

21. The apparatus of claim 17, further comprising:
logic configured to track the arbiter selection by the tracker circuit.

22. The apparatus of claim 17, further comprising:
logic configured to store the output of the comparator from the previous clock cycle by the delay cell circuit.

23. The apparatus of claim 17, further comprising:
logic configured to prevent subsequent requests to the arbiter and any arbiter selected request made from the previous clock cycle, if comparison of the tracker circuit output and the delay cell circuit output is unequal.

24. A apparatus for reducing latency in a System-on-a-Chip (SoC), the SoC having a bus with a master clock, a controller coupled to the bus, an arbiter coupled to the bus configured to select an initiator, the apparatus comprising:
means for monitoring activity within the SoC by an activity counter;
means for receiving a reference pattern detection logic clocked by an always on clock;
means for receiving a master pattern detection logic configured to operate on an activity based clock;
means for comparing the reference pattern detection logic and the master pattern detection logic by a comparator;
means for tracking selection of components within the SoC by a tracker circuit;
means for storing output of components within the SoC by a delay cell circuit; and
means for preventing request to the arbiter and any arbiter selected request made from previous clock cycles, depending on the tracker circuit output and the delay cell circuit output, by a request mask circuit.

25. The apparatus of claim 24, further comprising:
means for gating off at least one of the clocks for the SoC to enter low power state.

26. The apparatus of claim 24, further comprising:
means for controlling activity within the SoC;
means for counting inactivity cycles by a bus interface activity counter; and
means for signaling to a clock controller, to gate off at least one of the clocks.

27. The apparatus of claim 24, further comprising:
means for comparing the reference pattern detection logic with the master pattern detection logic to determine if the master clock is active, by the comparator.

28. The apparatus of claim 24, further comprising:
means for tracking the arbiter selection by the tracker circuit.

29. The apparatus of claim 24, further comprising:
means for storing the output of the comparator from the previous clock cycle by the delay cell circuit.

30. The apparatus of claim 24, further comprising:
means for preventing subsequent request to the arbiter and any arbiter selected request made from previous clock cycle, by the request mask circuit, if comparison of the tracker circuit output and the delay cell circuit output is unequal.
